(19) United States
(12) Patent Application Publication
(10) Pub. No.: US 2010/0189843 A1
(43) Pub. Date: Jul. 29, 2010

(54) Hydroxypropylated Starch as a Processing Aid to Improve Resistant Starch Total Dietary Fiber (TDF) Retention in Direct Expansion Extrusion Applications

(76) Inventors: Wei Luke Xie, Decatur, IL (US); Donald Wayne Harris, Springfield, IL (US); Brenda L. Waite, Ewing, NJ (US); Judy L. Turner, Decatur, IL (US); Doris A. Dougherty, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/692,151

(22) Filed: Jan. 22, 2010

Related U.S. Application Data
(60) Provisional application No. 61/146,842, filed on Jan. 23, 2009.

(51) Int. Cl. A21D 13/06; A21D 2/00; A23P 1/14; A23P 1/12

(52) U.S. Cl. 426/72; 426/555; 426/550; 426/541; 426/559; 426/516; 426/560

(57) ABSTRACT

A composition comprising from about 3% d.s.b. to about 35% d.s.b. of a first starch, wherein the degree of substitution (DS) of the first starch with a hydroxypropyl group is from about 0.1 to about 0.6; from about 10% d.s.b. to about 50% d.s.b. of a second starch; and from about 15% d.s.b. to about 87% d.s.b. of a flour or a meal. A method, comprising extruding a composition as described above and from about 15% total weight to about 25% total weight water at a temperature from room temperature to about 200° C., to yield an extruded composition comprising less than about 5% total weight water.

This application claims priority from U.S. provisional patent application Ser. No. 61/146,842, filed on Jan. 23, 2009, which is incorporated herein by reference.

### BACKGROUND OF THE INVENTION

The present disclosure relates to processes for manufacture, such as by extrusion, of foods having a relatively high total dietary fiber (TDF) content.

### SUMMARY OF THE INVENTION

In one embodiment, the present invention relates to a composition comprising from about 3% d.s.b. to about 35% d.s.b. of a first starch, wherein the degree of substitution (DS) of the first starch with a hydroxypropyl group is from about 0.1 to about 0.6; from about 10% d.s.b. to about 50% d.s.b. of a second starch; and from about 15% d.s.b. to about 87% d.s.b. of a flour or a meal.

In one embodiment, the present invention relates to a method comprising extruding a composition comprising from about 3% d.s.b. to about 35% d.s.b. of a first starch, wherein the degree of substitution (DS) of the first starch with a hydroxypropyl group is from about 0.1 to about 0.6; from about 10% d.s.b. to about 50% d.s.b. of a second starch; and from about 15% d.s.b. to about 87% d.s.b. of a flour or a meal; and from about 15% total weight to about 25% total weight water at a temperature from room temperature to about 200° C., to yield an extruded composition comprising less than about 5% total weight water.

### DESCRIPTION OF ILLUSTRATIVE EMBODIMENTS

In one embodiment, the present invention relates to a composition comprising from about 3% d.s.b. to about 35% d.s.b. of a first starch, wherein the degree of substitution (DS) of the first starch with a hydroxypropyl group is from about 0.1 to about 0.6; from about 10% d.s.b. to about 50% d.s.b. of a second starch; and from about 15% d.s.b. to about 87% d.s.b. of a flour or a meal.

The first starch can come from a variety of sources, including starches obtained from dent corn, high amylose ae genetic corn (ae is the name of a genetic mutation commonly known by corn breeders and is short for “amylose extender”), waxy corn (a starch containing essentially no amylose and consisting essentially of amylopectin), potato, tapioca, rice, pea, and wheat varieties, as well as purified amylose or amylopectin from these starches, among others. The first starch may be a combination of two more types of starches discussed above.

In one embodiment, the first starch is selected from the group consisting of wheat starch, dent corn starch, high amylose corn starch, waxy corn starch, tapioca starch, potato starch, and mixtures thereof.

In one embodiment, the composition comprises from about 5% d.s.b. to about 35% d.s.b of the first starch. For example, the composition can comprise from about 5% d.s.b. to about 20% d.s.b of the first starch.

The hydroxypropyl group is linked to the monosaccharide unit by an ether linkage. Hydroxypropylation can be performed by techniques known in the art. Though not to be bound by theory, we expect the hydroxypropyl units added to the starch molecular chains to act as internal plasticizers and/or to have a high water binding capacity.

The DS values stated herein are calculated as follows:

DS=162*wt %/(100*M−(M−1)*wt %)

wherein DS is the degree of substitution (moles of substituent per mole of anhydrous glucose); 162 is the molecular weight (Da) of a monosaccharide unit; wt % is the weight percentage of the substituent in the substituted starch; and M is the molecular weight of the substituent (for hydroxypropyl groups, 56 Da).

In one embodiment, the DS of the first starch with a hydroxypropyl group is from about 0.2 to about 0.5.

The first starch can also be chemically modified in a manner other than hydroxypropylation. For example, the first starch can be a starch adipate, an acetylated starch, or phosphorylated starch. Suitable chemically modified starches also include, but are not limited to, acid-thinned starches, crosslinked starches, acetylated and organically esterified starches, hydroxyethylated starches, phosphorylated and inorganically esterified starches, cationic, anionic, nonionic, and zwitterionic starches, and succinate and substituted succinate derivatives of starch. Such modifications are known in the art, for example in Modified Starches: Properties and Uses, Ed. Wurzburg, CRC Press, Inc., Florida (1986). Other suitable modifications and methods are disclosed in U.S. Pat. Nos. 4,626,288, 2,613,206 and 2,661,349, which are incorporated herein by reference. In one embodiment, the first starch is crosslinked, either before or after hydroxypropylation.

The second starch can come from a variety of sources, including those starches discussed above as being appropriate for use as the first starch, among others.

In one embodiment, the second starch is a digestion resistant starch. A “digestion resistant starch” is used herein to refer to a starch that is relatively insusceptible to digestion by the digestive system of man or another mammal. Both in vitro and in vivo tests can be performed to estimate rate and extent of carbohydrate digestion. For example, the “Englyst Assay” is an in vitro enzyme test that can be used to estimate the amounts of a carbohydrate ingredient that are rapidly digestible, slowly digestible or resistant to digestion (European Journal of Clinical Nutrition (1992) Volume 46 (Suppl. 2), pages S33-S50). In one embodiment, a “resistant starch” is one in which the sum of the percentages that are classified as slowly digestible or as resistant by the Englyst assay totals at least about 50%. For another example, AOAC 991.43 is a standard for measuring total dietary fiber (TDF). In one embodiment, a “resistant starch” is one in which the TDF value as measured by AOAC 991.43 is at least about 30% d.s.b. Higher TDF values are possible; for example, the second starch can have a TDF value as measured by AOAC 991.43 of at least about 58% d.s.b. The second starch can have a TDF value as measured by AOAC 991.43 greater than 58% d.s.b.

As is known in the art, resistant starches can be characterized as belonging to one of four different types. Type I resistant starch is physically inaccessible to digestive enzymes, with examples being found in seeds, legumes, and unprocessed whole grains. Type II resistant starch occurs in its natural granular form, such as uncooked potato, green banana flour and high amylose corn. Type III resistant starch is formed when starch-containing foods are cooked and cooled, such as bread, many breakfast cereals, cooked-and-chilled potatoes, and retrograded high amylose corn. Type IV resistant starches have been chemically modified to resist digestion.

In one embodiment, the second starch is selected from the group consisting of Type I resistant starches, Type II resistant starches, Type III resistant starches, Type IV resistant starches, and two or more thereof.

In one embodiment, the composition comprises from about 15% d.s.b. to about 50% d.s.b. of the second starch. For example, the composition can comprise from about 15% d.s.b. to about 25% d.s.b. of the second starch.

The composition also comprises a flour or a meal. Flours and meals are known in the art. In one embodiment, the flour or the meal is selected from the group consisting of corn meal, corn flour, wheat flour, rice flour, barley flour, oat flour, potato flour, amaranth flour, and two or more thereof.

The composition has been described as comprising the first starch, the second starch, and the flour or meal. In one embodiment, the composition further comprises one or more other materials.

In a particular embodiment, the composition further comprises one or more materials selected from the group consisting of flavorants, food dyes, vitamins, minerals, antioxidants, fatty acids, lipids, salts, sugars, and two or more thereof.

In another embodiment, the composition further comprises a fiber material. For example, in a particular embodiment, the composition further comprises from about 1% d.s.b. to about 30% d.s.b. of a fiber material selected from the group consisting of oat bran, oat fiber, corn bran, cellulosic fiber, and two or more thereof.

In yet another embodiment, the composition further comprises a protein material, by which is meant a material containing more than about 50 wt % oligo- or polypeptides or both. For example, in a particular embodiment, the composition further comprises from about 1% d.s.b. to about 30% d.s.b. of a protein material selected from the group consisting of casein, whey, wheat protein, and two or more thereof.

The composition can be in any one of a number of forms. In one embodiment, the composition is in the form of a dough, by which is meant the composition contains the ingredients discussed above and from about 14% total weight to about 25% total weight water. This amount of water renders the dough susceptible to kneading, extrusion, and similar processing steps.

In another embodiment, the composition is in the form of an edible product having from 0% total weight to about 25% total weight water, such as less than about 5% total weight water. The edible product can be prepared by the action of heat, high pressure, or both on a dough to form a desired shape of the edible product, with subsequent drying in air or an oven to yield a desired moisture level.

In one particular embodiment, the composition is expanded (a.k.a. “puffed”) by incorporating air into the composition as it is being formed into an edible product. In one embodiment, the composition is in the form of an expanded snack item or an expanded cereal item. An extrusion process for preparing an expanded food item will be discussed in detail below.

In one embodiment, the present invention relates to a method comprising extruding a composition comprising from about 3% d.s.b. to about 35% d.s.b. of a first starch, wherein the degree of substitution (DS) of the first starch with a hydroxypropyl group is from about 0.1 to about 0.6; from about 10% d.s.b. to about 50% d.s.b. of a second starch; and from about 15% d.s.b. to about 87% d.s.b. of a flour or a meal; and from about 14% total weight to about 25% total weight water at a temperature from room temperature to about 200° C., to yield an extruded composition comprising less than about 5% total weight water.

The first starch, second starch, and flour or meal have been described above. The second starch can be a resistant starch. In one embodiment, the total weight of water is from approximately about 12% to about 25%, such as from about 14% to about 22%, or for a further example, from about 16% to about 22%.

Extrusion processes are known in the art. In general, extrusion apparatus is well suited to handle production of foodstuffs from high-viscosity, high-solids compositions, such as doughs. Specific examples of extrusion apparatus include single-screw and twin-screw extruders. Such extrusion apparatus is commercially available. In one embodiment, the extruder screw speed can vary from about 250 rpm to about 500 rpm. Temperatures from room temperature to about 200° C., such as from about 40° C. to about 150° C., can be used in the various zones of the extruder, although a composition may transiently encounter a higher temperature during one or more portions of the extrusion process.

The dough may be premade and then fed to the extruder, or it may be formed in the extruder by the combination of one or more dry ingredients with any of the other dry ingredients, water, or both.

In one embodiment, the extruded composition is expanded or “puffed.” A single piece of the puffed extrudate may be referred to herein as a “puff.” In a particular embodiment, expansion can be affected by performing the extrusion process in a manner to generate high pressure at the die face, creating a puffing force that when released to atmosphere (going through the die) results in expansion of the matrix.

After extrusion, the extrudate may be further processed by baking, drying, pelletizing or otherwise forming, or packaging, among others. For example, the extrudate may be dried in an oven at 100° C. for 10 min. The extrudate may be intended for direct consumption or it may be fed to another process for forming a foodstuff, e.g., the extrudate may be coated with an edible coating, molded by itself or with other edible materials to form a snack bar, combined with other edible materials in a trail mix, or otherwise processed into a foodstuff. Any further processing of the extrudate desired to yield a particular foodstuff can be performed as a routine matter for the person of ordinary skill in the art.

In one embodiment, the extruded composition is in the form of an expanded snack item or an expanded cereal item.

Often, when extruding compositions containing resistant starch according to the state of the art prior to our work, there is considerable reduction in fiber content (as observed by TDF analysis) by extrusion, due to high shear and heat producing physical changes in resistant starch during the extrusion process. TDF retention is significantly influenced by extrusion processing, such as, screw speed, dough moisture, and screw configuration.

Process modifications, such as adding water during extrusion, have been tried by persons of ordinary skill in the art to improve resistant starch retention, and with some success; however, products from these methods often do not puff to an extent desired for expanded snack items or expanded cereal items, among other expanded foodstuffs. This poor expansion results in unacceptable food products with high bulk density.

Other approaches to retain resistant starch during extrusion include reducing shear by changing screw configuration or reduction in screw speed, however this also reduces productivity.

Though not to be bound by theory, our observations suggest that the hydroxypropylated first starch in the composition acts as a plasticizer or improves processing flow characteristics during extrusion, giving expanded foodstuffs with high TDF at high process throughput.

Additionally, though again not to be bound by theory, the high water binding capacity of the hydroxypropylated first starch increases the glass transition temperature of second starch during extrusion processing. The higher glass transition temperature property of second starch provides better resistant to the high shear stress introduced in food extrusion processing, and therefore allows highly expanded foods with high TDF.

The term “retained total dietary fiber” or “retained TDF” is used herein to refer to the percentage of TDF that an extruded composition has relative to its TDF prior to extrusion. The TDF prior to extrusion is defined as 100%.

In one embodiment, the extruded composition has a retained total dietary fiber (retained TDF) value as measured by AOAC Method 991.43 from about 50% to 100% of its TDF value as measured by AOAC Method 991.43 prior to extruding.

The retained TDF values of a composition of the present invention are generally higher than those of compositions lacking any hydroxypropylated starch.

In one embodiment, a second composition, extruded identically to an extruded composition of the present invention, and, prior to extruding, being identical to the extruded composition except that the first starch of the second composition has a DS of hydroxypropyl groups of 0, has a retained TDF value less than the retained TDF value of the extruded composition.

It is generally the case that the higher the hydroxypropylated starch content of an extruded composition, the higher the retained TDF. In one embodiment, a third composition, extruded identically to the extruded composition, and, prior to extruding, being identical to the extruded composition except that fewer monosaccharide units of the first starch of the third composition contain a hydroxypropyl group than of the first starch of the extruded composition, has a retained TDF value less than the retained TDF value of the extruded composition.

The bulk density of an extruded composition of the present invention is generally low. In one embodiment, the extruded composition has a bulk density less than about 120 kg/m³, such as less than about 100 kg/m³. As should be apparent, the bulk density is greater than 0 kg/m³. If the bulk density of the extruded product is sufficiently low, additional water can be added during extrusion. We expect the additional water would improve TDF retention while maintaining the low bulk density desired for a puffed edible product.

The bulk density of an extruded composition of the present invention is generally lower than the bulk density of compositions lacking any hydroxypropylated starch. In one embodiment, the extruded composition of the present invention has a bulk density from about 15% less to about 30% less than a bulk density of a second composition, wherein the second composition is identically extruded and, prior to extruding, the second composition is identical to the extruded composition except that 0 mol% of monosaccharide units of the first starch of the second composition contain a hydroxypropyl group. This reduced bulk density for extruded compositions of the present invention also applies when the extruded composition and the second composition are identically expanded.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

We tested hydroxypropylated starch products as processing aids following preliminary results which suggested HP starches might result in retention of more resistant starch TDF during extrusion to form puffed snack or cereal products.

Starch Processing Aids—Food starch products manufactured by Tate & Lyle, Decatur, Ill., were tested as potential extrusion processing aids. These starch products are listed below.

Potential Starch Processing Aids

| | | Typical HP | |
|---|---|---|---|
| Starch | Base Starch | content (wt %) | DS |
| Starch 1 | Waxy corn | 5 | 0.15 |
| Starch 2 | Waxy corn | 9.5 | 0.30 |
| Starch 3 | Waxy corn | 13 | 0.45 |

Lab Extrusion—A co-rotating intermeshing twin screw Model BCTL 42 Extruder, manufactured by Buhler Inc., Uzweil, Switzerland, was used to evaluate different starch processing aids for direct expansion extrusion of mixtures of corn meal, PROMITOR™ Resistant Starch 60 (Tg=150° C.) with TDF of 58% (d.s.b.), and the processing aids. Dry blends were made up using either 15% or 7.5% of the starch processing aid, 30% resistant starch and sufficient corn meal to give 100% total. Dry blends are shown below.

Composition of Dry Blends

| | Processing Aid | Processing | Promitor ™ 60 | |
|---|---|---|---|---|
| | Starch | Aid | Resistant Starch | Corn |
| Sample | Description | Starch, % | % as is | Meal, % |
| 1A | Control | None | 30 | 70.0 |
| 1B | Starch 1 | 15.0 | 30 | 55.0 |
| 1C | Starch 1 | 7.5 | 30 | 62.5 |
| 1D | Starch 2 | 15.0 | 30 | 55.0 |
| 1E | Starch 2 | 7.5 | 30 | 62.5 |
| 1F | Starch 3 | 15.0 | 30 | 55.0 |
| 1G | Starch 3 | 7.5 | 30 | 62.5 |

Water was pumped at approximately 2.9 Kg/hr in an effort to maintain dough moisture content of approximately 19%. The six barrel heating zones were maintained as outlined below.

Barrel Temperature Profile

Zone

| | A | B | C | D | E | F |
|---|---|---|---|---|---|---|
| Temperature | N/A | 60 | 70 | 90 | 120 | 150 |
| ° C. | | | | | | |

The screw speed during extrusion was maintained at 350 rpm and the feed rate was 30kg/h. After extrusion the extruded products were dried in a lab convection oven to approximately 3% to 4% moisture content. Total dietary fiber (TDF) analysis was determined using AOAC Method 991.43 using a Megazyme test kit (Bray, County Wicklow, Ireland). Actual extrusion conditions of the trials are shown below.

| | | | | | | | | | | | TDF | |
|---|---|---|---|---|---|---|---|---|---|---|---|---|
| | | | water | Die | Die | | | | | | dry | TDF |
| | | Dry | pump | plate | plate | | | | | Bulk | basis % | retention |
| | | Blends | rate | pressure | temp | dough | Torque | | SME | Density | (AOAC | (AOAC |
| Example | Description | Moisture % | (kg/h) | (bars) | ° C. | moisture % | (NM | Torque % | (wh/kg) | (kg/m3) | 991.43) | 991.43) |
| 1A | control | 11.2 | 2.9 | 27.9 | 169 | 19 | 183 | 45 | 203 | 79 | 10.1 | 64.7 |
| 1B | Starch 1-15% | 11.2 | 2.8 | 22.4 | 170 | 19 | 218 | 54 | 247 | 63 | 10.4 | 66.7 |
| 1C | Starch 1-7.5% | 11.0 | 2.9 | 25.7 | 171 | 19 | 194 | 48 | 213 | 65 | 10.7 | 68.6 |
| 1D | Starch 2-15% | 10.3 | 3.1 | 23.1 | 171 | 19 | 206 | 51 | 233 | 60 | 12.2 | 78.2 |
| 1E | Starch 2-7.5% | 10.8 | 3.0 | 23.1 | 171 | 19 | 189 | 47 | 220 | 57 | 10.8 | 69.2 |
| 1F | Starch 3-15% | 10.5 | 3.0 | 26.1 | 172 | 19 | 204 | 50 | 236 | 62 | 13.9 | 89.1 |
| 1G | Starch 3-7.5% | 10.8 | 2.9 | 25.1 | 172 | 19 | 195 | 48 | 225 | 59 | 11.7 | 75.0 |

### Example 2

Resistant starch (Tg=120° C.) at TDF of 66% (d.b.$) was tested with 0%, 15% and 25% starch 2 (HP content=9.5 wt %) using various dough moisture was tested. Dry blends are show below.

| | Processing | Resistant | | |
|---|---|---|---|---|
| | Aid | Starch % | | Dough Moisture |
| Example | Starch 2% | as is | Corn Meal, % | Inside Extruder % |
| 2A | 0 | 30 | 70 | 15 |
| 2B | 0 | 30 | 70 | 18 |
| 2C | 0 | 30 | 70 | 21 |
| 2D | 0 | 20 | 80 | 15 |
| 2E | 0 | 20 | 80 | 18 |
| 2F | 0 | 20 | 80 | 21 |
| 2G | 15 | 30 | 55 | 15 |
| 2H | 15 | 30 | 55 | 18 |
| 2I | 15 | 30 | 55 | 21 |
| 2J | 15 | 20 | 65 | 15 |
| 2K | 15 | 20 | 65 | 18 |
| 2L | 15 | 20 | 65 | 21 |
| 2M | 25 | 25 | 50 | 15 |
| 2N | 25 | 25 | 50 | 18 |
| 2O | 25 | 25 | 50 | 21 |

Actual extrusion conditions of the trials and TDF for each example are shown below.

| | | Water | | | | | | | | |
|---|---|---|---|---|---|---|---|---|---|---|
| | Dry | pump | | Die plate | Die plate | | | Bulk | | |
| | Blends | rate | Dough | pressure | temperature | Torque | | Density | TDF % | % TDF |
| Example | Moisture % | (kg/h) | moisture % | (bars) | (° C.) | (NM) | Torque % | (kg/m³) | (d.s.b) | retention |
| 2A | 9.8 | 1.8 | 15 | 49.7 | 174 | 170 | 42 | 73 | 9.4 | 34.8 |
| 2B | 9.8 | 3.0 | 18 | 39.1 | 167 | 151 | 38 | 98 | 13.1 | 54.4 |
| 2C | 9.8 | 4.2 | 21 | 24.9 | 163 | 136 | 33 | 123 | 15.8 | 68.9 |
| 2D | 9.6 | 1.9 | 15 | 47.4 | 175 | 168 | 41 | 69 | 7.0 | 29.5 |
| 2E | 9.6 | 3.1 | 18 | 39.0 | 167 | 148 | 37 | 103 | 9.4 | 48.4 |
| 2F | 9.6 | 4.4 | 21 | 27.5 | 161 | 131 | 32 | 139 | 10.9 | 60.6 |
| 2G | 9.1 | 2.1 | 15 | 38.2 | 171 | 239 | 59 | 73 | 12.5 | 51.1 |
| 2H | 9.1 | 3.3 | 18 | 25.2 | 164 | 228 | 57 | 110 | 15.8 | 68.9 |
| 2I | 9.1 | 4.5 | 21 | 19.7 | 156 | 222 | 55 | 151 | 19.3 | 87.2 |
| 2J | 9.5 | 1.9 | 15 | 34.8 | 174 | 278 | 70 | 66 | 8.3 | 40.1 |
| 2K | 9.5 | 3.1 | 18 | 25.8 | 165 | 225 | 55 | 96 | 11.1 | 62.1 |
| 2L | 9.5 | 4.3 | 21 | 17.3 | 162 | 201 | 50 | 118 | 13.0 | 77.7 |
| 2M | 8.8 | 2.1 | 15 | 35.1 | 172 | 279 | 70 | 68 | 11.8 | 55.5 |
| 2N | 8.8 | 3.3 | 18 | 25.4 | 164 | 242 | 60 | 105 | 15.0 | 76.1 |
| 2O | 8.8 | 4.5 | 21 | 14.6 | 160 | 210 | 52 | 128 | 17.4 | 91.7 |

Results of TDF retention from using the various starch processing aids are presented above.

It can be seen that as the % HP content of the processing aid starch was increased, the TDF retention of the resistant starch increased when compared to the control where no processing aid was utilized. In addition, the bulk density values were reduced vs. the control. Very low bulk density values are desirable for two reasons. First, there is a maximum value resulting in good product conformation and eating quality. Second, if bulk density is sufficiently low, additional water can be added during extrusion. The higher moisture during extrusion will improve TDF retention while still maintaining the low bulk density required for a good quality puffed product.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A composition, comprising:
from about 3% d.s.b. to about 35% d.s.b. of a first starch, wherein the degree of substitution (DS) of the first starch with a hydroxypropyl group is from about 0.1 to about 0.6;
from about 10% d.s.b. to about 50% d.s.b. of a second starch; and
from about 15% d.s.b. to about 87% d.s.b. of a flour or a meal.

2. The composition of claim 1, comprising from about 5% d.s.b. to about 20% d.s.b of the first starch.

3. The composition of claim 1, wherein the first starch is selected from the group consisting of wheat starch, dent corn starch, high amylose corn starch, waxy corn starch, tapioca starch, potato starch, and mixtures thereof.

4. The composition of claim 1, wherein the DS of the first starch with a hydroxypropyl group is from about 0.2 to about 0.5.

5. The composition of claim 1, comprising from about 15% d.s.b. to about 25% d.s.b. of the second starch.

6. The composition of claim 1, wherein the second starch has a total dietary fiber (TDF) value as measured by AOAC 991.43 of at least about 40% d.s.b.

7. The composition of claim 6, wherein the second starch has a TDF value as measured by AOAC 991.43 of at least about 58% d.s.b.

8. The composition of claim 6, wherein the second starch is selected from the group consisting of Type I resistant starches, Type II resistant starches, Type III resistant starches, Type IV resistant starches, and two or more thereof.

9. The composition of claim 1, wherein the flour or the meal is selected from the group consisting of corn meal, corn flour, wheat flour, rice flour, barley flour, oat flour, potato flour, amaranth flour, and two or more thereof.

10. The composition of claim 1, further comprising one or more materials selected from the group consisting of flavorants, food dyes, vitamins, minerals, antioxidants, fatty acids, lipids, salts, sugars, and two or more thereof.

11. The composition of claim 1, further comprising from about 1% d.s.b. to about 30% d.s.b. of a fiber material selected from the group consisting of oat bran, oat fiber, corn bran, cellulosic fiber, and two or more thereof.

12. The composition of claim 1, further comprising from about 1% d.s.b. to about 30% d.s.b. of a protein material selected from the group consisting of casein, whey, wheat protein, and two or more thereof.

13. The composition of claim 1, wherein the composition is in the form of an expanded snack item or an expanded cereal item.

14. The composition of claim 1, wherein the composition comprises from 0% total weight to about 25% total weight water.

15. The composition of claim 14, wherein the composition comprises from about 14% total weight to about 25% total weight water.

16. A method, comprising:
extruding a composition comprising from about 3% d.s.b. to about 35% d.s.b. of a first starch, wherein the degree of substitution (DS) of the first starch with a hydroxypropyl group is from about 0.1 to about 0.6; from about 10% d.s.b. to about 50% d.s.b. of a second starch; and from about 15% d.s.b. to about 87% d.s.b. of a flour or a meal; and from about 12% total weight to about 25% total weight water at a temperature from room temperature to about 200° C., to yield an extruded composition comprising less than about 5% total weight water.

17. The method of claim 16, comprising from about 5% d.s.b. to about 20% d.s.b of the first starch.

18. The method of claim 16, wherein the first starch is selected from the group consisting of wheat starch, dent corn starch, high amylose corn starch, waxy corn starch, tapioca starch, potato starch, and mixtures thereof.

19. The method of claim 16, wherein the DS of the first starch with a hydroxypropyl group is from about 0.2 to about 0.5.

20. The method of claim 16, comprising from about 15% d.s.b. to about 50% d.s.b. of the second starch.

21. The method of claim 16, wherein the second starch has a total dietary fiber (TDF) value as measured by AOAC 991.43 of at least about 30% d.s.b.

22. The method of claim 21, wherein the second starch has a TDF value as measured by AOAC 991.43 of at least about 58% d.s.b.

23. The method of claim 21, wherein the second starch is selected from the group consisting of Type I resistant starches, Type II resistant starches, Type III resistant starches, Type IV resistant starches, and two or more thereof.

24. The method of claim 16, wherein the flour or the meal is selected from the group consisting of corn meal, corn flour, wheat flour, rice flour, barley flour, oat flour, amaranth flour, and two or more thereof.

25. The method of claim 16, wherein the composition further comprises one or more materials selected from the group consisting of flavorants, food dyes, vitamins, minerals, antioxidants, fatty acids, lipids, salts, sugars, and two or more thereof.

26. The method of claim 16, wherein the composition further comprises from about 1% d.s.b. to about 30% d.s.b. of a fiber material selected from the group consisting of oat bran, oat fiber, corn bran, cellulosic fiber, and two or more thereof.

27. The method of claim 16, wherein the composition further comprises from about 1% d.s.b. to about 30% d.s.b. of a protein material selected from the group consisting of casein, whey, wheat protein, and two or more thereof.

28. The method of claim 16, further comprising expanding the extruded composition.

29. The method of claim 28, wherein the extruded composition is in the form of an expanded snack item or an expanded cereal item.

30. An extruded composition produced by the method of claim 16, wherein the extruded composition has a retained total dietary fiber (retained TDF) value as measured by AOAC Method 991.43 from about 50% to 100% of its TDF value as measured by AOAC Method 991.43 prior to extruding.

31. The extruded composition of claim 30, wherein a second composition, extruded identically to the extruded composition, and, prior to extruding, being identical to the extruded composition except that the DS of hydroxypropyl groups of the first starch of the second composition is 0, has a retained TDF value less than the retained TDF value of the extruded composition.

32. The extruded composition of claim 30, wherein the extruded composition has a bulk density less than about 120 kg/m³.

33. The extruded composition of claim 32, wherein the extruded composition has a bulk density from about 15% less to about 30% less than a bulk density of a second composition, wherein the second composition is identically extruded and, prior to extruding, the second composition is identical to the extruded composition except that the DS of hydroxypropyl groups of the first starch of the second composition is 0.

34. The extruded composition of claim 33, wherein the extruded composition and the second composition are identically expanded.
